(19) United States
(12) Patent Application Publication
(10) Pub. No.: US 2023/0342879 A1
(43) Pub. Date: Oct. 26, 2023

(54) DATA PROCESSING APPARATUS, DATA PROCESSING METHOD, AND NON-TRANSITORY COMPUTER-READABLE MEDIUM

(71) Applicant: NEC CORPORATION, Minato-ku, Tokyo (JP)

(72) Inventors: Kazumine OGURA, Tokyo (JP); Nagma Samreen KHAN, Tokyo (JP); Tatsuya SUMIYA, Tokyo (JP); Shingo YAMANOUCHI, Tokyo (JP); Masayuki ARIYOSHI, Tokyo (JP); Toahiyuki NOMURA, Tokyo (JP)

(73) Assignee: NEC CORPORATION, Minato-ku, Tokyo (JP)

(21) Appl. No.: 18/022,424

(22) PCT Filed: Aug. 27, 2020
(86) PCT No.: PCT/JP2020/032314

§ 371 Date: Feb. 21, 2023

(51) Int. Cl. G06T 3/00; G06T 7/70; G06T 7/50

(52) U.S. Cl. CPC G06T 3/0093; G06T 7/70; G06T 7/50

(57) ABSTRACT

A data processing apparatus (100) includes a target object position determination unit (103) that determines, based on a picture image acquired by a first camera, a position of a target object in the picture image, a target object depth distance extraction unit (104) that extracts the depth distance from the first camera to the target object, a coordinate transformation unit (105) that transforms the position of the target object in the picture image into a position of the target object in a world coordinate system by using the depth distance, and a label transformation unit (106) that transforms, by using a position of the first camera in the world coordinate system and imaging information used when an image is generated from a measurement result of a sensor, the position of the target object in the world coordinate system into a label of the target object in the image.

### TECHNICAL FIELD

The present invention relates to a data processing apparatus, a data processing method, and a program.

### BACKGROUND ART

Body scanners using radar are introduced at airports and the like and detect hazardous materials. In a radar system in Non-Patent Document 1, an antenna (radar 2) placed in an x-y plane (a panel 1 in FIG. 21) in a part (A) of FIG. 21 radiates a radio wave and measures a signal reflected from an object (pedestrian). The mechanism generates a radar image, based on the measured signal, and detects a hazardous material (a target object in a part (B) of FIG. 21) from the generated radar image.

Further, Patent Document 1 describes performing the following processing when identifying a target object existing in a surveillance area. First, data relating to distances to a plurality of objects existing in the surveillance area are acquired from a measurement result of a three-dimensional laser scanner. Next, a change area in which the difference between current distance data and past distance data is equal to or greater than a threshold value is extracted. Next, an image is generated by transforming a front view image based on the current distance data and the change area into an image in which a viewpoint of the three-dimensional laser scanner is moved. Then, based on the front view image and the image generated by a coordinate transformation unit, a plurality of objects existing in the surveillance area are identified.

### RELATED DOCUMENT

### Patent Document

[Patent Document 1]: International Application Publication No. WO 2018/142779

### Non-Patent Document

[Non-Patent Document 1]: David M. Sheen, Douglas L. McMakin, and Thomas E. Hall, “Three-Dimensional Millimeter-Wave Imaging for Concealed Weapon Detection,” IEEE Transactions on Microwave Theory and Techniques, vol. 49, No. 9, September 2001

### SUMMARY OF THE INVENTION

### Technical Problem

A generated radar image is represented by three-dimensional voxels with x, y, and z in FIG. 21 as axes. FIG. 22 illustrates the three-dimensional radar image in FIG. 21 being projected in the z-direction. In object detection using machine learning, labeling of a detected object in a radar image is required as illustrated in a part (A) of FIG. 22. Labeling can be performed when the shape of a detection target can be visually recognized in a radar image as illustrated in a part (B) of FIG. 22. On the other hand, it is often the case that the shape of a detection target in a radar image is unclear and cannot be visually recognized due to detection targets being in different poses as is the case in the part (B) of FIG. 22. This is caused by clearness of the shape of a detection target being dependent on the size and the pose of the detection target, reflection intensity, and the like. In this case, labeling becomes difficult, which causes incorrect labeling. As a result, a model with poor detection performance may be generated due to learning based on an incorrect label.

A problem to be solved by the present invention is to increase precision of labeling in an image.

### Solution to Problem

The present invention provides a data processing apparatus including:
a target object position determination unit determining, based on a picture image acquired by a first camera, a position of a target object in the picture image;
a target object depth distance extraction unit extracting a depth distance from the first camera to the target object;
a coordinate transformation unit transforming the position of the target object in the picture image into a position of the target object in a world coordinate system by using the depth distance; and
a label transformation unit transforming, by using the position of the first camera in the world coordinate system and imaging information used when an image is generated from a measurement result of a sensor, the position of the target object in the world coordinate system into a label of the target object in the image.

The present invention provides a data processing apparatus including:
a target object position determination unit determining, based on a picture image acquired by a first camera, a position of a target object in the picture image;
a target object depth distance extraction unit extracting a depth distance from the first camera to the target object by using a radar image generated based on a radar signal;
a coordinate transformation unit transforming the position of the target object in the picture image into a position of the target object in a world coordinate system, based on the depth distance; and
a label transformation unit transforming the target object position in the world coordinate system into a label of the target object in the radar image by using a position of the first camera in the world coordinate system and imaging information of a sensor.

The present invention provides a data processing apparatus including:
a marker position determination unit determining, based on a picture image acquired by a first camera, a position of a marker attached to a target object in the picture image as a position of the target object in the picture image;
a target object depth distance extraction unit extracting a depth distance from the first camera to the target object by using a radar image generated based on a radar signal generated by a sensor;
a coordinate transformation unit transforming a position of a target object in the picture image into a position of the target object in a world coordinate system by using a depth distance from the first camera to a target object; and
a label transformation unit transforming the position of the target object in the world coordinate system into a label of the target object in the radar image by using a camera position in the world coordinate system and imaging information of the sensor.

The present invention provides a data processing method executed by a computer, the method including:
target object position determination processing of determining, based on a picture image acquired by a first camera, a position of a target object in the picture image;
target object depth distance extraction processing of extracting a depth distance from the first camera to the target object;
coordinate transformation processing of transforming a position of the target object in the picture image into a position of the target object in a world coordinate system by using the depth distance; and
label transformation processing of transforming the position of the target object in the world coordinate system into a label of the target object in the image by using a position of the first camera in the world coordinate system and imaging information used when an image is generated from a measurement result of a sensor.

The present invention provides a program causing a computer to have:
a target object position determination function of determining, based on a picture image acquired by a first camera, a position of a target object in the picture image;
a target object depth distance extraction function of extracting a depth distance from the first camera to the target object;
a coordinate transformation function of transforming the position of the target object in the picture image into a position of the target object in a world coordinate system by using the depth distance; and
a label transformation function of transforming, by using the position of the first camera in the world coordinate system and imaging information used when an image is generated from a measurement result of a sensor, the position of the target object in the world coordinate system into a label of the target object in the image.

### Advantageous Effects of Invention

The present invention can increase precision of labeling in an image.

### BRIEF DESCRIPTION OF THE DRAWINGS

The aforementioned object, other objects, features and advantages will become more apparent by the following preferred example embodiments and accompanying drawings.

FIG. 1 is a block diagram of a first example embodiment.

FIG. 2 is a flowchart of the first example embodiment.

FIG. 3 is a block diagram of a second example embodiment.

FIG. 4 is a flowchart of the second example embodiment.

FIG. 5 is a block diagram of a third example embodiment.

FIG. 6 is a flowchart of the third example embodiment.

FIG. 7 is a block diagram of a fourth example embodiment.

FIG. 8 is a flowchart of the fourth example embodiment.

FIG. 9 is a block diagram of a fifth example embodiment.

FIG. 10 is a flowchart of the fifth example embodiment.

FIG. 11 is a block diagram of a sixth example embodiment.

FIG. 12 is a flowchart of the sixth example embodiment.

FIG. 13 is a block diagram of a seventh example embodiment.

FIG. 14 is a flowchart of the seventh example embodiment.

FIG. 15 is a block diagram of an eighth example embodiment.

FIG. 16 is a flowchart of the eighth example embodiment.

FIG. 17 is a block diagram of a ninth example embodiment.

FIG. 18 is a flowchart of the ninth example embodiment.

FIG. 19 is a block diagram of a tenth example embodiment.

FIG. 20 is a flowchart of the tenth example embodiment.

FIG. 21 is a diagram illustrating a system overview [(A) three-dimensional view, (B) top view].

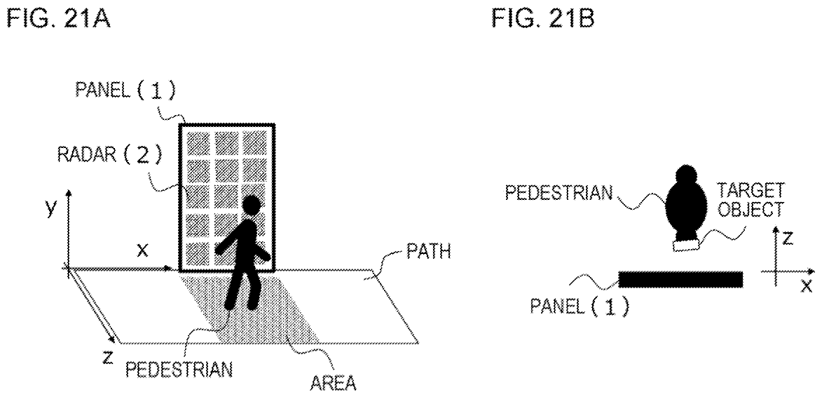

FIG. 22 is a diagram illustrating a problem of a label in a radar image.

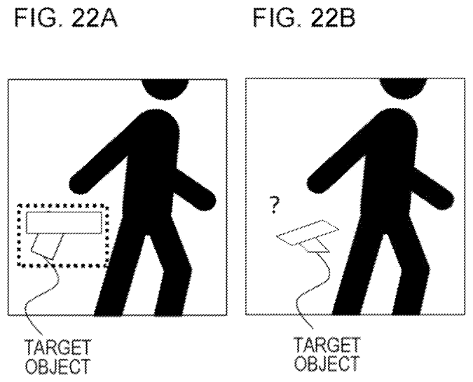

FIG. 23 is a diagram illustrating an example embodiment [(A) three-dimensional view, (B) top view].

FIG. 24 is a diagram illustrating an example of labeling according to the example embodiment [(A) a label in a camera picture image, (B) a label in a radar image].

FIG. 25 is a diagram illustrating variations of a camera position.

FIG. 26 is a diagram illustrating variations of method for a target object position determination in a camera picture image.

FIG. 27 is a diagram illustrating a target object depth distance.

FIG. 28 is a diagram illustrating a three-dimensional radar image (radar coordinate system).

FIG. 29 is a diagram illustrating an operation example of a label transformation unit.

FIG. 30 is a diagram illustrating an operation example of alignment.

FIG. 31 is a diagram illustrating an example of depth distance extraction.

FIG. 32 is a diagram illustrating a type of a marker.

FIG. 33 is a diagram illustrating an example of distortion of markers.

FIG. 34 is a diagram illustrating an example of a hardware configuration of a data processing apparatus.

### DESCRIPTION OF EMBODIMENTS

Example embodiments of the present invention will be described below by using drawings. Note that, in every drawing, similar components are given similar signs, and description thereof is omitted as appropriate.

### First Example Embodiment

### [Configuration]

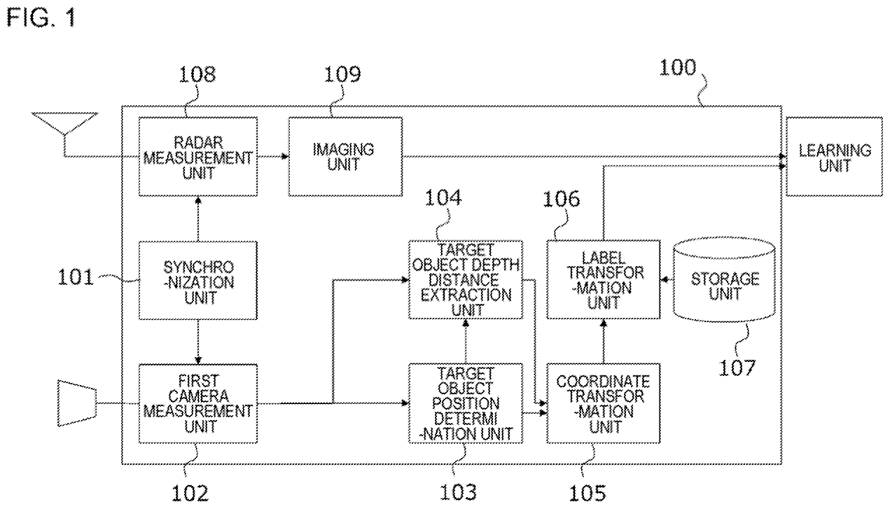

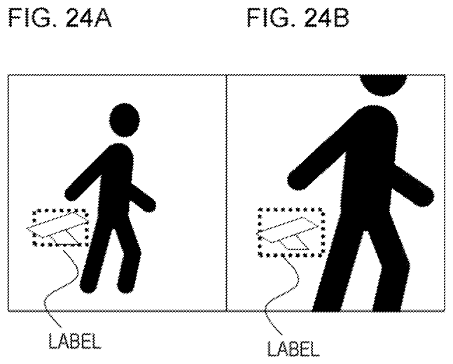

A first example embodiment will be described with reference to FIG. 1. A data processing apparatus 100 includes a synchronization unit 101 transmitting a synchronization signal for synchronizing measurement timings, a first camera measurement unit 102 instructing a first camera to perform image capture, a target object position determination unit 103 determining a position of a target object in a picture image acquired by the first camera (such as a label in a picture image illustrated in a part (A) of FIG. 24), a target object depth distance extraction unit 104 extracting the depth distance from the first camera to a target object, based on a camera picture image, a coordinate transformation unit 105 transforming a position of a target object in a picture image acquired by the first camera into a position of the target object in a world coordinate system, based on the depth distance from the first camera to the target object, a label transformation unit 106 transforming a position of a target object in the world coordinate system into a label of the target object in a radar image (such as a label in a radar image illustrated in a part (B) of FIG. 24), a storage unit 107 holding the position of the first camera and radar imaging information, a radar measurement unit 108 performing signal measurement at an antenna of a radar, and an imaging unit 109 generating a radar image from a radar measurement signal.

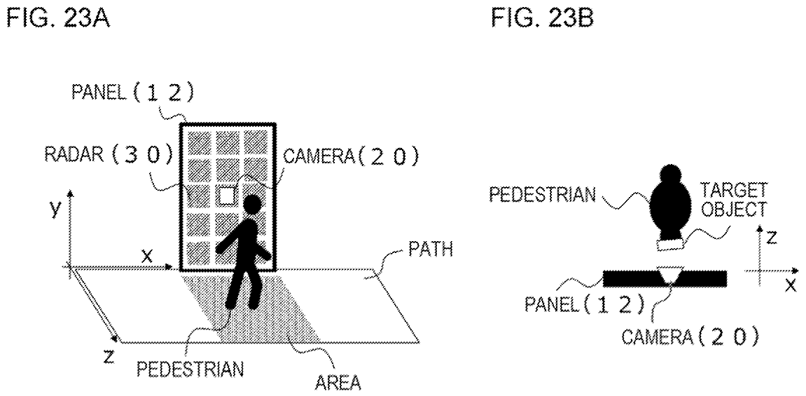

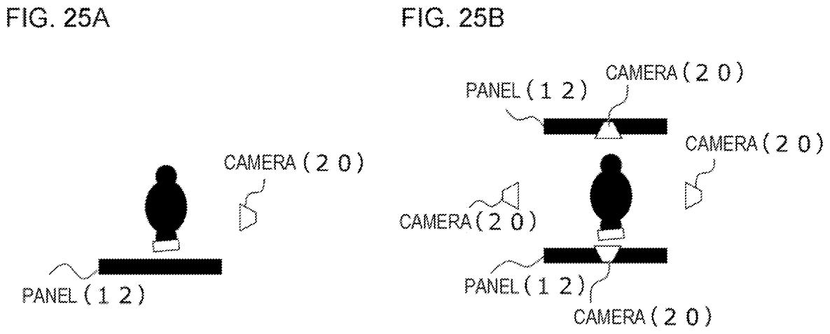

A radar system is also part of the data processing apparatus 100. The radar system also includes a camera 20 and a radar 30 illustrated in FIG. 23. The camera 20 is an example of a first camera to be described later. Note that, a plurality of cameras 20 may be provided as illustrated in a part (B) of FIG. 25. In this case, at least one of the plurality of cameras 20 is an example of the first camera.

The synchronization unit 101 outputs a synchronization signal to the first camera measurement unit 102 and the radar measurement unit 108 in order to synchronize measurement timings. For example, the synchronization signal is output periodically. When a labeling target object moves with the lapse of time, the first camera and the radar need to be precisely synchronized; however, when the labeling target object does not move, synchronization precision is not essential.

The first camera measurement unit 102 receives a synchronization signal from the synchronization unit 101 as an input and when receiving the synchronization signal, outputs an image capture instruction to the first camera. Further, the first camera measurement unit 102 outputs a picture image captured by the first camera to the target object position determination unit 103 and the target object depth distance extraction unit 104. A camera capable of computing the distance from the first camera to a target object is used as the first camera. For example, a depth camera [such as a time-of-flight (ToF) camera, an infrared camera, or a stereo camera] is used. It is assumed in the following description that a picture image captured by the first camera is a depth picture image with a size of wₚᵢₓₑₗ×hₚᵢₓₑₗ. It is assumed that an installation position of the first camera is a position where the first camera can capture an image of a detection target. The first camera may be installed on a panel 12 on which an antenna of the radar 30 is installed, as illustrated in FIG. 23, or may be placed on a walking path, as illustrated in a part (A) of FIG. 25. Further, the radar system according to the present example embodiment also operates when each of a plurality of cameras 20 placed at positions different from one another as illustrated in a part (B) of FIG. 25 is used as the first camera. Two panels 12 are installed in such a way as to sandwich a walking path in the example illustrated in FIG. 25. Then, a camera 20 facing the walking path side is installed on each of the two panels 12, and cameras 20 are installed in front of and behind the panels 12, respectively, in a forward direction of the walking path. It is hereinafter assumed that a camera is placed at the position in FIG. 23.

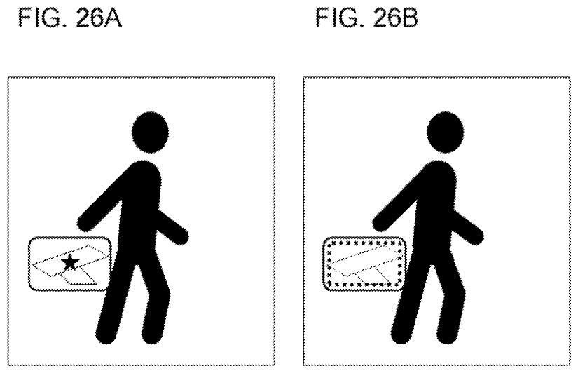

The target object position determination unit 103 receives a picture image from the first camera measurement unit 102 as an input and outputs a position of a target object in a picture image acquired by the first camera to the target object depth distance extraction unit 104 and the coordinate transformation unit 105. As the position of the target object, a case of selecting the center position of the target object as illustrated in a part (A) of FIG. 26, a case of selecting an area (rectangle) including the target object as illustrated in a part (B) of FIG. 26, or the like may be considered. The determined position of the target object in the picture image is denoted as (x_{img}, y_{img}). When an area is selected, the position of the target object may be determined by four points (four corners of a rectangle) or by two points being a starting point and an ending point.

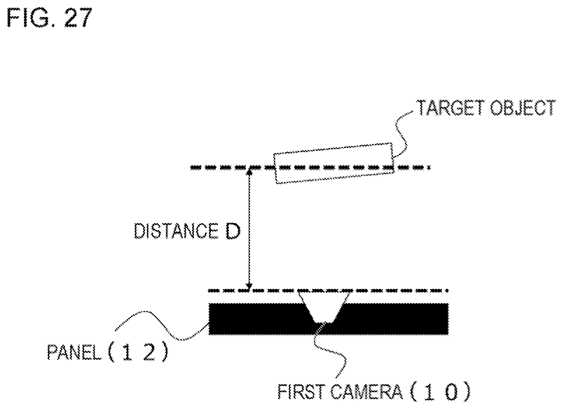

The target object depth distance extraction unit 104 receives a picture image from the first camera measurement unit 102 and a position of a target object in the picture image from the target object position determination unit 103 as inputs and outputs the depth distance from the first camera to the target object to the coordinate transformation unit 105, based on the picture image and the target object position in the picture image. The depth distance herein refers to a distance D from a plane on which the first camera is installed to a plane on which the target object is placed, as illustrated in FIG. 27. The distance D is the depth of a position (x_{img}, y_{img}) of the target object in a depth picture image being the picture image acquired by the first camera.

The coordinate transformation unit 105 receives a target object position in a picture image from the target object position determination unit 103 and a depth distance from the target object depth distance extraction unit 104 as inputs, computes a position of the target object in a world coordinate system, based on the target object position in the picture image and the depth distance, and outputs the position of the target object to the label transformation unit 106. The target object position (X′_{target}, Y′_{target}, Z′_{target}) in the world coordinate system herein assumes the position of the first camera as the origin, and dimensions correspond to x, y, and z axes in FIG. 23. Denoting the focal distance of the first camera in the x-direction as fₓ and the focal distance of the first camera in the y-direction as f_{y}, the target object position (X′_{target}, Y′_{target}, Z′_{target}) is computed from the target object position (x_{img}, y_{img}) in the picture image and the depth distance D by Equation (1).

$$\begin{matrix}[ Math . 1 ] & \\ [ \begin{matrix}{X}_{target}^{′} \\ {Y}_{target}^{′} \\ {Z}_{target}^{′}\end{matrix} ] = [ \begin{matrix}1 / {f}_{x} & 0 & 0 \\ 0 & 1 / {f}_{y} & 0 \\ 0 & 0 & 1\end{matrix} ] [ \begin{matrix}{x}_{img} \\ {y}_{img} \\ 1\end{matrix} ] \times D & ( 1 )\end{matrix}$$

The label transformation unit 106 receives a target object position in the world coordinate system from the coordinate transformation unit 105 and receives the position of the first camera and radar imaging information to be described later from the storage unit 107, as inputs; and the label transformation unit 106 transforms the target object position in the world coordinate system into a label of the target object in radar imaging, based on the radar imaging information, and outputs the label to a learning unit. The position (X′_{target}, Y′_{target}, Z′_{target}) of the target object received from the coordinate transformation unit 105 is based on an assumption that the position of the first camera is the origin. A position (X_{target}, Y_{target}, Z_{target}) of the target object with the radar position as the origin can be computed by Equation (2) below by using the position (X_{camera}, Y_{camera}, Z_{camera}) of the first camera received from the storage unit 107 with the radar position in the world coordinate system as the origin.

$$\begin{matrix}[ Math . 2 ] & \\ [ \begin{matrix}{X}_{target} \\ {Y}_{target} \\ {Z}_{target}\end{matrix} ] = [ \begin{matrix}{X}_{target}^{′} \\ {Y}_{target}^{′} \\ {Z}_{target}^{′}\end{matrix} ] + [ \begin{matrix}{X}_{camera} \\ {Y}_{camera} \\ {Z}_{camera}\end{matrix} ] & ( 2 )\end{matrix}$$

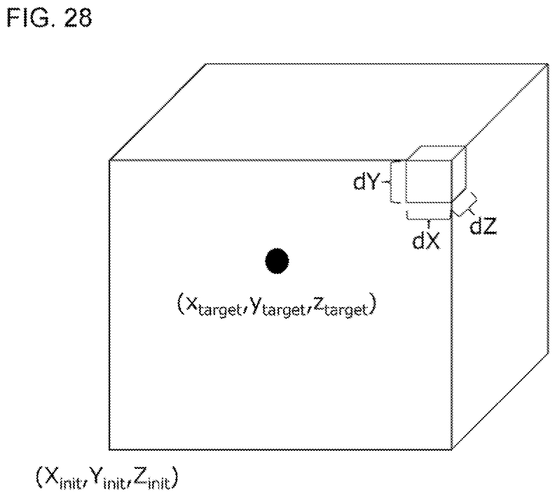

Further, the label transformation unit 106 derives a position of the target object in radar imaging, based on the target object position with the radar position as the origin and the radar imaging information received from the storage unit 107, and determines the position to be a label. The radar imaging information refers to a starting point (Xᵢₙᵢₜ, Yᵢₙᵢₜ, Zᵢₙᵢₜ) of an imaging area of radar imaging in the world coordinate system and respective lengths dX, dY, and dZ per voxel in the x-, y-, and z-directions in radar imaging, as illustrated in FIG. 28. A position (X_{target}, Y_{target}, Z_{target}) of the target object in radar imaging can be computed by Equation (3).

$$\begin{matrix}[ Math . 3 ] & \\ [ \begin{matrix}{x}_{target} \\ {y}_{target} \\ {z}_{target}\end{matrix} ] = [ \begin{matrix}( {X}_{target} - {X}_{init} ) / dX \\ ( {Y}_{target} - {Y}_{init} ) / dY \\ ( {Z}_{target} - {Z}_{init} ) / dZ\end{matrix} ] & ( 3 )\end{matrix}$$

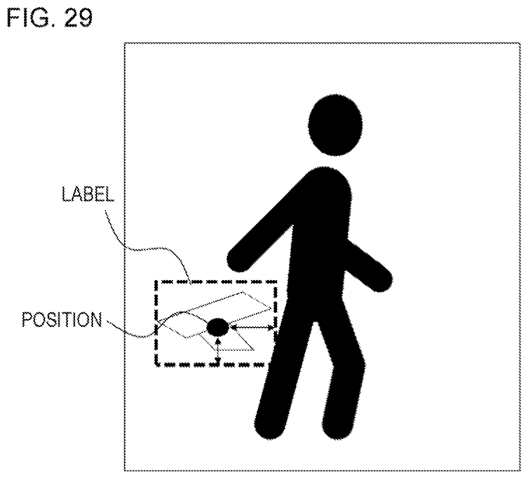

Note that when the target object position determination unit 103 selects one point (the center of a target object) as a position of the target object, as illustrated in the part (A) of FIG. 26, the position of the target object here is also one point, and therefore when the size of the target object is known, transformation into a label having width and height corresponding to the size of the target object with the position of the target object as the center may be performed, as illustrated in FIG. 29. When there are a plurality of target object positions as illustrated in the part (B) of FIG. 26, the aforementioned computation may be performed on each position, and transformation into a final label may be performed based on a plurality of acquired target object positions. For example, when there are four target object positions (x_{target}{1-4}, y_{target}{1-4}, z_{target} {1-4}), the starting point of the label may be determined as [min(x_{target}{1-4}), min(y_{target}{1-4}, min(z_{target}{1-4})], and the ending point of the label may be determined as [max(x_{target}{1-4}), max(y_{target}{1-4}), max(z_{target}{1-4})].

The storage unit 107 holds the position of the first camera in the world coordinate system assuming the radar position as the origin and radar imaging information. The radar imaging information refers to the starting point (Xᵢₙᵢₜ, Yᵢₙᵢₜ, Zᵢₙᵢₜ) of an imaging area (that is, an area being a target of an image) in radar imaging in the world coordinate system and respective lengths (dX, dY, dZ) in the world coordinate system per voxel in the x-, y-, z-directions in radar imaging, as illustrated in FIG. 28.

The radar measurement unit 108 receives a synchronization signal from the synchronization unit 101 as an input and instructs the antenna of a radar (such as the aforementioned radar 30) to perform measurement. Further, the radar measurement unit 108 outputs the measured radar signal to the imaging unit 109. In other words, the image capture timing of the first camera and the measurement timing of the radar are synchronized. It is assumed that there are Ntx transmission antennas, Nrx reception antennas, and Nk frequencies to be used. A radio wave transmitted by any transmission antenna may be received by a plurality of reception antennas. With regard to frequencies, it is assumed that frequencies are switched at a specific frequency width as is the case with the stepped frequency continuous wave (SWCF) method. It is hereinafter assumed that a radar signal S(it, jr, k) is radiated by a transmission antenna it at a k-th step frequency f(k) and is measured by a reception antenna jr.

The imaging unit 109 receives a radar signal from the radar measurement unit 108 as an input, generates a radar image, and outputs the generated radar image to the learning unit. In a generated three-dimensional radar image V(vetor(v)), the vector(v) denotes a position of one voxel v in the radar image and can be computed from the radar signal S(it, ir, k) by Equation (4) below.

$$\begin{matrix}[ Math . 4 ] & \\ V ( \vec{v} ) = {\sum }_{it = t}^{{N}_{tx}} {\sum }_{ir = 1}^{{N}_{rx}} {\sum }_{k = 1}^{{N}_{k}} ( S ( it , ir , k ) \cdot {e}^{\frac{2 π i \cdot f ( k )}{c} \cdot R ( \vec{v} , it , ir )} ) & ( 4 )\end{matrix}$$

Note that c denotes the speed of light, i denotes an imaginary number, and R denotes the distance from the transmission antenna it to the reception antenna ir through the voxel v. R is computed by Equation (5) below. A vector(Tx(it)) and a vector(Rx(ir)) denote positions of the transmission antenna it and the reception antenna ir, respectively.

[Math. 5]

R(\vec{v},it,ir)=|\vec{Tx(it)}−\vec{v}|+|\vec{Rx(ir)}−\vec{v}| (5)

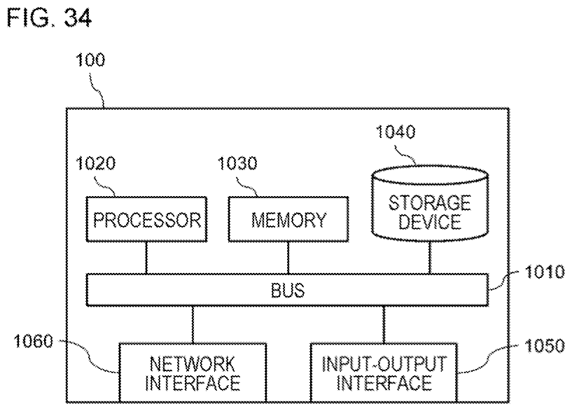

FIG. 34 is a diagram illustrating an example of a hardware configuration of a data processing apparatus 10. The data processing apparatus 10 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one another. Note that the method of interconnecting the processor 1020 and other components is not limited to a bus connection.

The processor 1020 is a processor provided by a central processing unit (CPU), a graphics processing unit (GPU), or the like.

The memory 1030 is a main storage provided by a random access memory (RAM) or the like.

The storage device 1040 is an auxiliary storage provided by a hard disk drive (HDD), a solid state drive (SSD), a memory card, a read only memory (ROM), or the like. The storage device 1040 stores program modules providing functions of the data processing apparatus 10. By the processor 1020 reading each program module into the memory 1030 and executing the program module, each function relating to the program module is provided. Further, the storage device 1040 may also function as various storage units.

The input-output interface 1050 is an interface for connecting the data processing apparatus 10 to various types of input-output equipment (such as each camera and the radar).

The network interface 1060 is an interface for connecting the data processing apparatus 10 to a network. For example, the network is a local area network (LAN) or a wide area network (WAN). The method of connecting the network interface 1060 to the network may be a wireless connection or a wired connection.

### [Description of Operation]

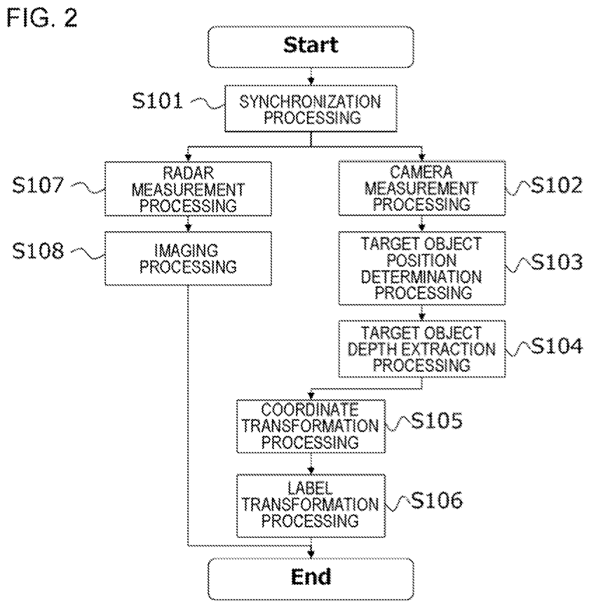

Next, an operation according to the present example embodiment will be described with reference to a flowchart in FIG. 2. First, synchronization processing (S101) is an operation of the synchronization unit 101 in FIG. 1 and outputs a synchronization signal to the first camera measurement unit 102 and the radar measurement unit 108.

Camera measurement processing (S102) is an operation of the first camera measurement unit 102 in FIG. 1; and the processing instructs the first camera to perform image capture at a timing when the synchronization signal is received and outputs a captured picture image to the target object position determination unit 103 and the target object depth distance extraction unit 104.

Target object position determination processing (S103) is an operation of the target object position determination unit 103 in FIG. 1; and the processing determines the position of a target object, based on the picture image acquired by the first camera, and outputs the position of the target object to the target object depth distance extraction unit 104 and the coordinate transformation unit 105.

Target object depth extraction processing (S104) is an operation of the target object depth distance extraction unit 104 in FIG. 1; and the processing extracts the depth distance from the first camera to the target object, based on the target object position in the picture image, and outputs the depth distance to the coordinate transformation unit 105.

Coordinate transformation processing (S105) is an operation of the coordinate transformation unit 105 in FIG. 1; and the processing transforms the target object position in the picture image into a target object position in a world coordinate system with the position of the first camera as the origin, based on the depth distance, and outputs the target object position to the label transformation unit 106. Label transformation processing (S106) is an operation of the label transformation unit 106; and the processing transforms the target object position in the world coordinates with the position of the first camera as the origin into a label of the target object in radar imaging and outputs the label to the learning unit. The position of the first camera with the radar position as the origin and radar imaging information are used in the transformation. Note that in the present example embodiment, a label includes positional information and indicates that a target object exists at the position.

Radar measurement processing (S107) is an operation of the radar measurement unit 108 in FIG. 1; and the processing instructs the antenna of the radar to perform measurement when the synchronization signal from the synchronization unit 101 is received and outputs the measured radar signal to the imaging unit 109.

Imaging processing (S108) is an operation of the imaging unit 109 in FIG. 1; and the processing receives the radar signal from the radar measurement unit 108, generates a radar image from the radar signal, and outputs the radar image to the learning unit. At the time of the output, the label generated in S106 is also output along with the radar image.

Note that S107 and S108 are executed in parallel with S102 to S106.

### [Advantageous Effect]

By labeling a target object the shape of which is unclear in a radar image with a picture image acquired by the first camera, the present example embodiment enables labeling in the radar image.

### Second Example Embodiment

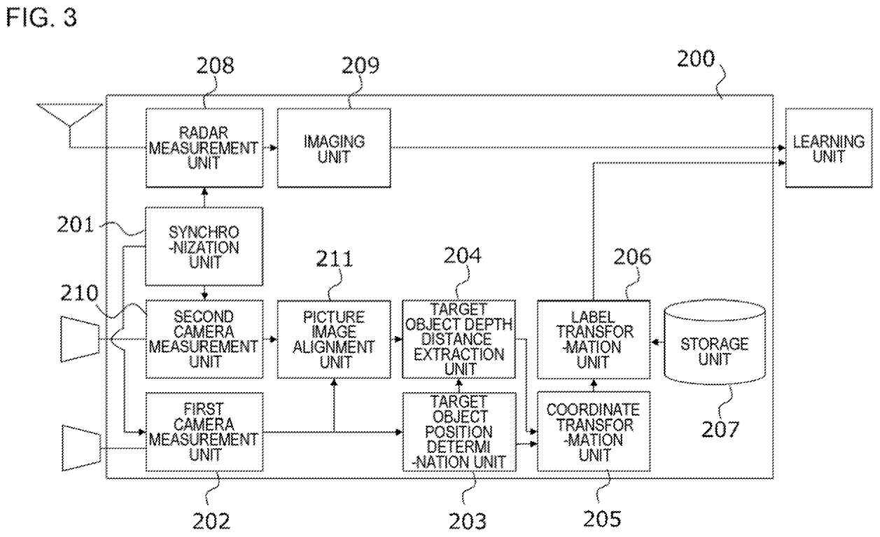

A second example embodiment will be described with reference to FIG. 3. A data processing apparatus 200 includes a synchronization unit 201 transmitting a synchronization signal for synchronizing measurement timings, a first camera measurement unit 202 giving an image capture instruction to a first camera, a target object position determination unit 203 determining a position of a target object in a picture image acquired by the first camera, a target object depth distance extraction unit 204 extracting a depth distance from the first camera to a target object, based on a picture image acquired by a second camera, a coordinate transformation unit 205 transforming a position of a target object in a picture image acquired by the first camera into a position of the target object in a world coordinate system, based on the depth distance from the first camera to the target object, a label transformation unit 206 transforming a position of a target object in the world coordinate system into a label of the target object in a radar image, a storage unit 207 holding the position of the first camera and radar imaging information, a radar measurement unit 208 performing signal measurement at an antenna of a radar, an imaging unit 209 generating a radar image from a radar measurement signal, a second camera measurement unit 210 giving an image capture instruction to the second camera, and a picture image alignment unit 211 aligning a picture image acquired by the first camera with a camera picture image acquired by the second camera.

At least part of an area an image of which is captured by the second camera overlaps an area an image of which is captured by the first camera. Therefore, a picture image generated by the first camera and a picture image generated by the second camera include the same target object. The following description is based on the assumption that the first camera and the second camera are positioned at the same location.

The synchronization unit 201 outputs a synchronization signal to the second camera measurement unit 210, in addition to the function of the synchronization unit 101.

The first camera measurement unit 202 receives a synchronization signal from the synchronization unit 101 as an input and when receiving the synchronization signal, outputs an image capture instruction to the first camera, similarly to the first camera measurement unit 102. Further, the first camera measurement unit 202 outputs a picture image captured by the first camera to the target object position determination unit 203 and the picture image alignment unit 211. Note that the first camera here may be a camera incapable of depth measurement. An example of such a camera is an RGB camera. However, the second camera is a camera capable of depth measurement.

The target object position determination unit 203 has the same function as the target object position determination unit 103, and therefore description thereof is omitted.

The target object depth distance extraction unit 204 receives a position of a target object in a picture image acquired by the first camera from the target object position determination unit 203 and receives a picture image being captured by the second camera and subjected to alignment by the picture image alignment unit 211, as inputs. Then, the target object depth distance extraction unit 204 extracts the depth distance from the second camera to the target object by a method similar to that by the target object depth distance extraction unit 104 and outputs the depth distance to the coordinate transformation unit 205. The picture image being acquired by the second camera and subjected to alignment has the same angle of view as the picture image acquired by the first camera, and therefore based on the position of the target object in the picture image acquired by the first camera, the depth of the position in a second depth picture image becomes the depth distance.

The coordinate transformation unit 205 has the same function as the coordinate transformation unit 105, and therefore description thereof is omitted.

The label transformation unit 206 has the same function as the label transformation unit 106, and therefore description thereof is omitted.

The storage unit 207 has the same function as the storage unit 107, and therefore description thereof is omitted.

The radar measurement unit 208 has the same function as the radar measurement unit 108, and therefore description thereof is omitted.

The imaging unit 209 has the same function as the imaging unit 109, and therefore description thereof is omitted.

The second camera measurement unit 210 receives a synchronization signal from the synchronization unit 201 and when receiving the synchronization signal, outputs an image capture instruction to the second camera. In other words, the image capture timing of the second camera is synchronized with the image capture timing of the first camera and the measurement timing of the radar. Further, the second camera measurement unit 210 outputs the picture image captured by the second camera to the picture image alignment unit 211. A camera capable of computing the distance from the second camera to a target object is used as the second camera. The camera corresponds to the first camera according to the first example embodiment.

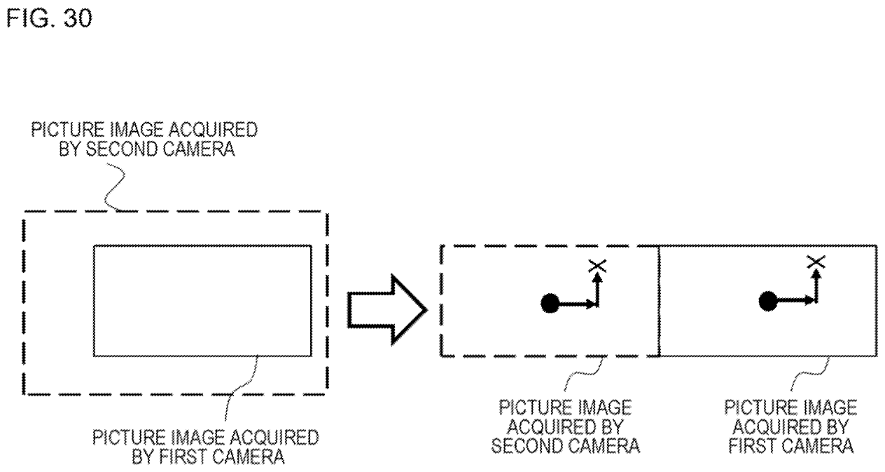

The picture image alignment unit 211 receives a picture image captured by the first camera from the first camera measurement unit 202 and receives a picture image captured by the second camera from the second camera measurement unit 210, as inputs, aligns the two picture images, and outputs the picture image being acquired by the second camera and subjected to alignment to the target object depth distance extraction unit 204. FIG. 30 illustrates an example of the alignment. Denoting the size of the first camera picture image as w1ₚᵢₓₑₗ×h1ₚᵢₓₑₗ and the size of the picture image acquired by the second camera as w2ₚᵢₓₑₗ×h2ₚᵢₓₑₗ, it is assumed in FIG. that an angle of view of the picture image acquired by the second camera is wider. In this case, a picture image is generated by adjusting the size of the second camera picture image to the size of the picture image acquired by the first camera. Consequently, any position in the picture image selected from the picture image acquired by the first camera in the diagram corresponds to the same position in the picture image acquired by the second camera, and viewing angles (angles of view) in the picture images become the same. When an angle of view of the picture image acquired by the second camera is narrower, alignment is not necessary.

### [Description of Operation]

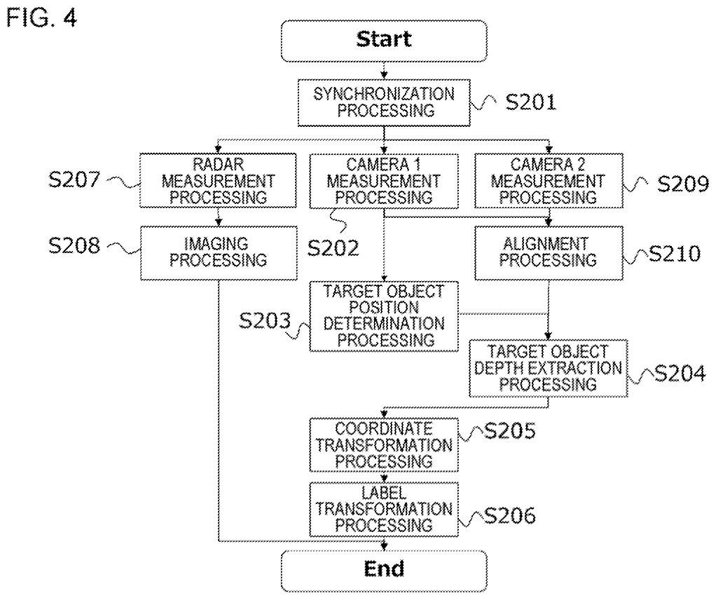

Next, an operation according to the present example embodiment will be described with reference to a flowchart in FIG. 4. First, synchronization processing (S201) is an operation of the synchronization unit 201 in FIG. 3 and outputs a synchronization signal to the first camera measurement unit 202, the radar measurement unit 208, and the second camera measurement unit 210.

Camera measurement processing (S202) is an operation of the first camera measurement unit 202 in FIG. 3; and the processing instructs the first camera to perform image capture at a timing when the synchronization signal is received and outputs the picture image captured by the first camera to the target object position determination unit 203 and the picture image alignment unit 211.

Target object position determination processing (S203) is an operation of the target object position determination unit 203 in FIG. 3; and the processing determines a position of a target object, based on the picture image acquired by the first camera, and outputs the position of the target object to the target object depth distance extraction unit 204 and the coordinate transformation unit 205.

Target object depth extraction processing (S204) is an operation of the target object depth distance extraction unit 204 in FIG. 3 and extracts the depth distance from the first camera to the target object. A specific example of the processing performed here is as described using FIG. 3. Then, the target object depth distance extraction unit 204 outputs the extracted depth distance to the coordinate transformation unit 205.

Coordinate transformation processing (S205) is an operation of the coordinate transformation unit 205 in FIG. 3; and the processing transforms the target object position in the picture image into a position of the target object in a world coordinate system with the position of the first camera as the origin, based on the depth distance, and outputs the position of the target object to the label transformation unit 206.

Label transformation processing (S206) is an operation of the label transformation unit 206; and the processing transforms the position of the target object in the world coordinates with the position of the first camera as the origin into a label of the target object in radar imaging, based on the position of the first camera with the radar position as the origin and radar imaging information, and outputs the label to a learning unit. A specific example of the label is similar to that in the first example embodiment.

Radar measurement processing (S207) is an operation of the radar measurement unit 208 in FIG. 3; and the processing instructs an antenna of the radar to perform measurement when the synchronization signal from the synchronization unit 201 is received and outputs the measured radar signal to the imaging unit 209.

Imaging processing (S208) is an operation of the imaging unit 209 in FIG. 3; and the processing receives the radar signal from the radar measurement unit 108, generates a radar image from the radar signal, and outputs the radar image to the learning unit.

Camera 2 measurement processing (S209) is an operation of the second camera measurement unit 210 in FIG. 3; and the processing instructs the second camera to perform image capture when the synchronization signal is received from the synchronization unit 201 and outputs the picture image captured by the second camera to the picture image alignment unit 211.

Alignment processing (S210) is an operation of the picture image alignment unit 211 in FIG. 3; and the processing receives the picture image acquired by the first camera from the first camera measurement unit and the picture image acquired by the second camera from the second camera measurement unit 210, performs alignment in such a way that the angle of view of the picture image acquired by the second camera become the same as the angle of view of the picture image acquired by the first camera, and outputs the picture image being captured by the second camera and subjected to alignment to the target object depth distance extraction unit 204.

Note that, S209 is executed in parallel with S202, and S203 is executed in parallel with S210. Furthermore, S207 and S208 are executed in parallel with S202 to S206, S209, and S210.

### [Advantageous Effect]

With respect to a target object the shape of which is unclear in a radar image, even when the position of the target object in a picture image acquired by the second camera cannot by determined, the present example embodiment enables labeling of the target object in the radar image as long as the position of the target object in a picture image acquired by the first camera can be determined.

### Third Example Embodiment

### [Configuration]

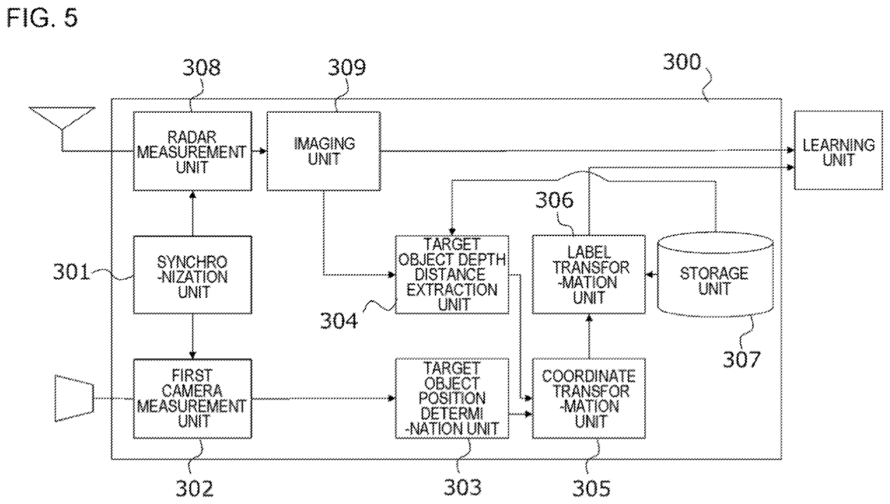

A third example embodiment will be described with reference to FIG. 5. A data processing apparatus 300 includes a synchronization unit 301 transmitting a synchronization signal for synchronizing measurement timings, a first camera measurement unit 302 giving an image capture instruction to a first camera, a target object position determination unit 303 determining a position of a target object in a picture image acquired by the first camera, a target object depth distance extraction unit 304 extracting a depth distance from the first camera to a target object, based on a radar image, a coordinate transformation unit 305 transforming a position of a target object in a picture image acquired by the first camera into a position of the target object in a world coordinate system, based on the depth distance from the first camera to the target object, a label transformation unit 306 transforming a position of a target object in the world coordinate system into a label of the target object in a radar image, a storage unit 307 holding the position of the first camera and radar imaging information, a radar measurement unit 308 performing signal measurement at an antenna of a radar, and an imaging unit 309 generating a radar image from a radar measurement signal.

The synchronization unit 301 has the same function as the synchronization unit 101, and therefore description thereof is omitted.

The first camera measurement unit 302 receives a synchronization signal from the synchronization unit 301 as an input, instructs the first camera to perform image capture at the timing, and outputs the captured picture image to the target object position determination unit 303. The first camera here may be a camera incapable of depth measurement, such as an RGB camera.

The target object position determination unit 303 receives a picture image acquired by the first camera from the first camera measurement unit 302, determines a target object position, and outputs the target object position in the picture image to the coordinate transformation unit 305.

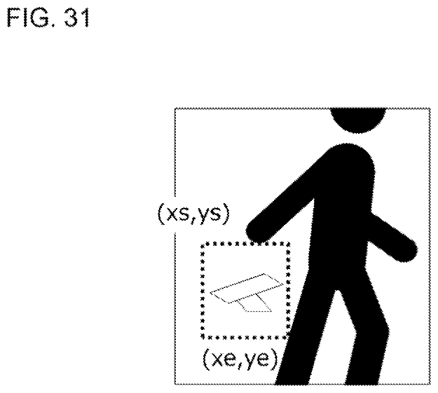

The target object depth distance extraction unit 304 receives a radar image from the imaging unit 309 and receives a position of the first camera in a world coordinate system with the radar position as the origin and radar imaging information from the storage unit 307, as inputs. Then, the target object depth distance extraction unit 304 computes the depth distance from the first camera to a target object and outputs the depth distance to the coordinate transformation unit 305. At this time, the target object depth distance extraction unit 304 computes the depth distance from the first camera to the target object by using the radar image. For example, the target object depth distance extraction unit 304 generates a two-dimensional radar image (FIG. 31) by projecting a three-dimensional radar image V in a z-direction and selecting voxels with the highest reflection intensity only. Next, the target object depth distance extraction unit 304 selects an area around the target object [a starting point (xs, ys) and an ending point (xe, ye) in the diagram] in the two-dimensional radar image and computes the depth distance by using z_{average} acquired by averaging z-coordinates of voxels having reflection intensity with a certain value or greater in the area. For example, the target object depth distance extraction unit 304 outputs the depth distance by using z_{average}, radar imaging information (the size dZ of one voxel in the z-direction and a starting point Zᵢₙᵢₜ of the radar image in the world coordinates), and the position of the first camera. For example, the depth distance (D) can be computed by Equation (6) below. Note that, it is assumed in Equation (6) that the position of the radar and the position of the first camera are the same.

[Math. 6]

D=z_{average}×dZ+Zᵢₙᵢₜ (6)

### [Description of Operation]

For example, the depth distance may be similarly computed by Equation (6) by determining a z-coordinate to the radar out of voxels having reflection intensity with a certain value or greater to be z_{average} without selecting an area in FIG. 31.

The coordinate transformation unit 305 has the same function as the coordinate transformation unit 105, and therefore description thereof is omitted.

The label transformation unit 306 has the same function as the label transformation unit 106, and therefore description thereof is omitted.

The storage unit 307 has the same information as the storage unit 107, and therefore description thereof is omitted.

The radar measurement unit 308 has the same function as the radar measurement unit 108, and therefore description thereof is omitted.

The imaging unit 309 outputs a generated radar image to the target object depth distance extraction unit 304, in addition to the function of the imaging unit 109.

### [Description of Operation]

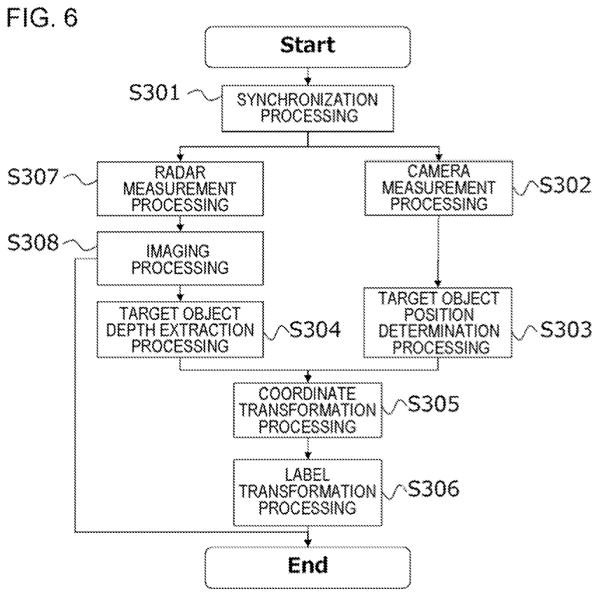

Next, an operation according to the present example embodiment will be described with reference to a flowchart in FIG. 6. Synchronization processing (S301) is the same as the synchronization processing (S101), and therefore description thereof is omitted.

Camera measurement processing (S302) is an operation of the first camera measurement unit 302 in FIG. 5; and the processing instructs the first camera to perform image capture at a timing when a synchronization signal is received from the synchronization unit 301 and outputs the picture image acquired by the first camera to the target object position determination unit 303.

Target object position determination processing (S303) is an operation of the target object position determination unit 303 in FIG. 5; and the processing determines a position of a target object, based on the picture image being captured by the first camera and being received from the first camera measurement unit 302 and outputs the position of the target object to the coordinate transformation unit 305.

Target object depth extraction processing (S304) is an operation of the target object depth distance extraction unit 304 in FIG. 5; and the processing computes the depth distance from the first camera to the target object by using a radar image received from the imaging unit 309, and a position of the first camera in a world coordinate system with a radar position as the origin and radar imaging information that are received from a sensor DB312 and outputs the depth distance to the coordinate transformation unit 305. Details of the processing are as described above using FIG. 5.

Coordinate transformation processing (S305) is the same as the coordinate transformation processing (S105), and therefore description thereof is omitted.

Label transformation processing (S306) is the same as the label transformation processing (S106), and therefore description thereof is omitted.

Radar measurement processing (S307) is the same as the radar measurement processing (S107), and therefore description thereof is omitted.

Imaging processing (S308) is an operation of the imaging unit 309 in FIG. 5; and the processing receives a radar signal from the radar measurement unit 308, generates a radar image from the radar signal, and outputs the radar image to the target object depth distance extraction unit 304 and a learning unit.

### [Advantageous Effect]

With respect to a target object the shape of which is unclear in a radar image, even when the depth distance from the first camera to the target object cannot be determined by the first camera, the present example embodiment enables labeling of the target object in the radar image as long as the position of the target object in the picture image acquired by the first camera can be determined by computing the depth distance from the first camera to the target object, based on the radar image.

### Fourth Example Embodiment

### [Configuration]

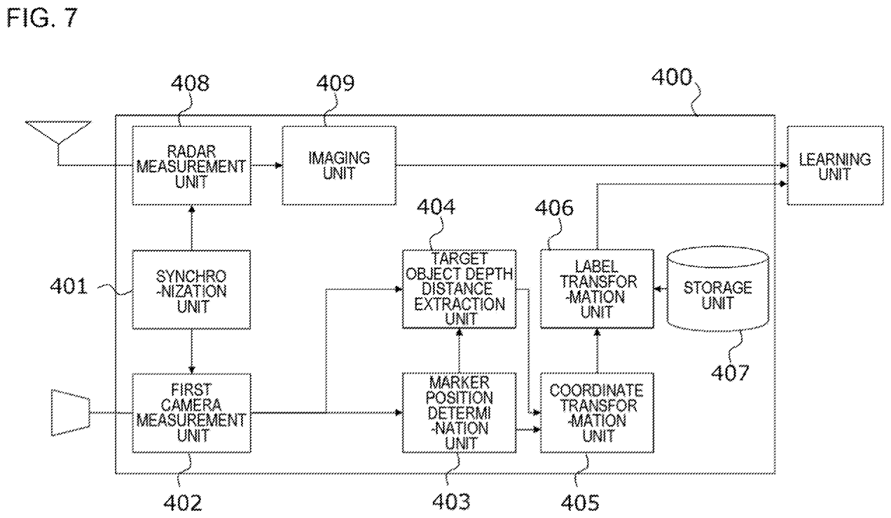

A fourth example embodiment will be described with reference to FIG. 7. The only difference between a data processing apparatus 400 according to the present example embodiment and the first example embodiment is a marker position determination unit 403 and a target object depth distance extraction unit 404, and therefore only the two units will be described. A first camera here may be a camera incapable of depth measurement, such as an RGB camera.

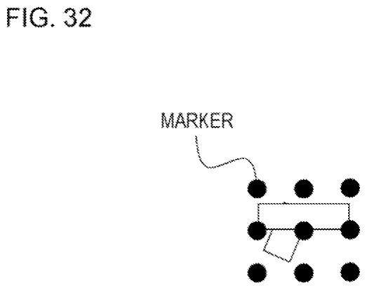

The marker position determination unit 403 determines a position of a marker from a picture image received from a first camera measurement unit 402 as an input and outputs the position of the marker to the target object depth distance extraction unit 404. Furthermore, the marker position determination unit 403 outputs the position of the marker to a coordinate transformation unit 405 as a position of a target object. It is assumed here that a marker can be easily and visually recognized by the first camera and can easily penetrated by a radar signal. For example, a marker can be composed of materials such as paper, wood, cloth, and plastic. Further, a marker may be painted on a material which a radar sees through. A marker is installed on the surface of a target object or at a location being close to the surface and being visually recognizable from the first camera. When a target object is hidden under a bag or clothing, a marker is placed on the surface of the bag or the clothing hiding the target object. Consequently, even when the target object cannot be visually recognized directly from a picture image of the first camera, the marker can be visually recognized, and an approximate position of the target object can be determined. A marker may be mounted around the center of a target object, or a plurality of markers may be mounted in such a way as to surround an area where a target object exists, as illustrated in FIG. 32. Further, a marker may be an AR marker. While markers are lattice points in the example in FIG. 32, the markers may be AR markers as described above. Means for determining a position of a marker in a picture image acquired by the first camera include determining a marker position by visually recognizing the marker position by the human eye and automatically determining a marker position by an image recognition technology such as common pattern matching or tracking. A shape and a size of a marker are not considered relevant in the following computations as long as the position of the marker can be computed from a picture image acquired by the first camera. The position of a marker positioned at the center out of lattice point markers in a picture image is hereinafter denoted as (x_{marker_c}, y_{marker_c}), and the positions of markers at four corners in the picture image are respectively denoted as (x_{marker_i}, y_{marker_i}) (where i=1, 2, 3, 4).

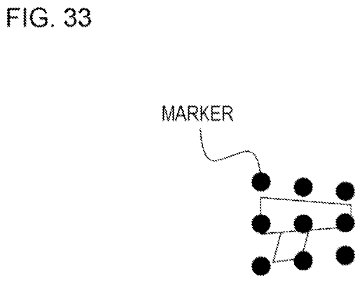

The target object depth distance extraction unit 404 receives a picture image from the first camera measurement unit 402 and a position of a marker from the marker position determination unit 403, as inputs, computes the depth distance from the first camera to a target object, based on the picture image and the position, and outputs the depth distance to the coordinate transformation unit 405. With respect to the computation method of the depth distance using a marker, when the first camera can measure a depth without a marker, a depth relating to the position of the marker in the picture image is determined to be the depth distance, as is the case in the first example embodiment. When the first camera cannot measure a depth without a marker as is the case with an RGB image, a position of the marker in the depth direction may be computed from the size of the marker in the picture image and a positional relation between the markers (distortion or the like of relative positions) as illustrated in FIG. 33, and the depth distance from the first camera to the target object may be estimated. For example, an AR marker allows computation of the depth distance from the camera to the marker even in an RGB image. An example of computing a position of a marker will be described below. The computation method varies with a marker type and an installation condition. A candidate position of a point positioned at the center of a marker in a world coordinate system with the first camera as the origin is denoted as (X′_{marker_c}, Y′_{marker_c}, Z′_{marker_c}), and conceivable coordinates of four corners of the marker based on rotations caused by rolling, pitching, and yawing with a point positioned at the center of the marker as a base point are denoted as (X′_{marker_i}, Y′_{marker_i}, Z′_{marker_i}) (where i=1, 2, 3, 4). For example, a candidate position of the point positioned at the center of the marker may be optionally selected from an imaging area being a target of a radar image. For example, the center point of each voxel in the entire area may be determined as a candidate position of the point positioned at the center of the marker. A marker position in the picture image acquired by the first camera, the position being computed from the coordinates of the four corners of the marker, is denoted as (x′_{marker_i}, y′_{marker_i}). For example, the marker position can be computed from Equation (7). Note that in Equation (7), fₓ denotes the focal distance of the first camera in an x-direction, and f_{y} denotes the focal distance of the first camera in a y-direction.

$$\begin{matrix}[ Math . 7 ] & \\ [ \begin{matrix}{x}_{marker \_ i}^{′} \\ {y}_{marker \_ i}^{′} \\ 1\end{matrix} ] \times {Z}_{marker \_ i}^{′} = [ \begin{matrix}{f}_{x} & 0 & 0 \\ 0 & {f}_{y} & 0 \\ 0 & 0 & 1\end{matrix} ] [ \begin{matrix}{X}_{marker \_ i}^{′} \\ {Y}_{marker \_ i}^{′} \\ {Z}_{marker \_ i}^{′}\end{matrix} ] & ( 7 )\end{matrix}$$

### [Description of Operation]

Based on the above and the positions of the four corners of the marker in the picture image, the positions being acquired by the marker position determination unit 403, an error E is computed by Equation (8). The marker position in the world coordinate system is estimated based on the error E. For example, Z′_{marker_c} being a marker position in the world coordinate system minimizing E is determined to be the depth distance from the first camera to the target object. Alternatively, Z′_{marker_i} being the four corners of the marker at this time may be determined as the distance from the first camera to the target object.

$$\begin{matrix}[ Math . 8 ] & \\ E = {Σ}_{i = 1 , 2 , 3 , 4} \sqrt{{( {x}_{marker \_ i} - {x}_{marker \_ i}^{′} )}^{2} + {( {y}_{marker \_ i} - {y}_{marker \_ i}^{′} )}^{2} + {( {z}_{marker \_ i} - {z}_{marker \_ i}^{′} )}^{2}} & ( 8 )\end{matrix}$$

### [Description of Operation]

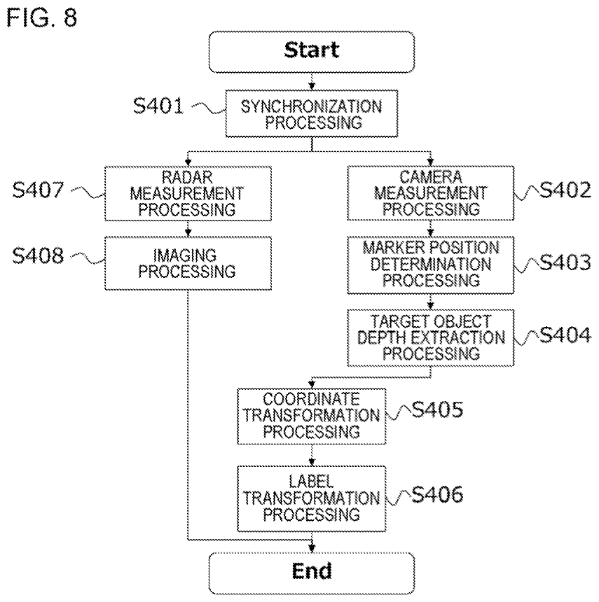

Next, an operation according to the present example embodiment will be described with reference to a flowchart in FIG. 8. The operation other than marker position determination processing (S403) and target object depth extraction processing (S404) is the same as the operation according to the first example embodiment, and therefore description thereof is omitted.

The marker position determination processing (S403) is an operation of the marker position determination unit 403 in FIG. 7; and the processing determines a position of a marker, based on a picture image being captured by the first camera and being received from the first camera measurement unit 402, outputs the position of the marker to the target object depth distance extraction unit 404, and further outputs the position of the marker to the coordinate transformation unit 405 as a position of a target object.

The target object depth extraction processing (S404) is an operation of the target object depth distance extraction unit 404 in FIG. 7; and the processing computes the depth distance from the first camera to the target object, based on the picture image received from the first camera measurement unit 402 and the position of the marker from the marker position determination unit 403, and outputs the depth distance to the coordinate transformation unit 405.

### [Advantageous Effect]

With respect to a target object the shape of which is unclear in a radar image, the present example embodiment enables more accurate labeling of the target object in the radar image by using a marker.

### Fifth Example Embodiment

### [Configuration]

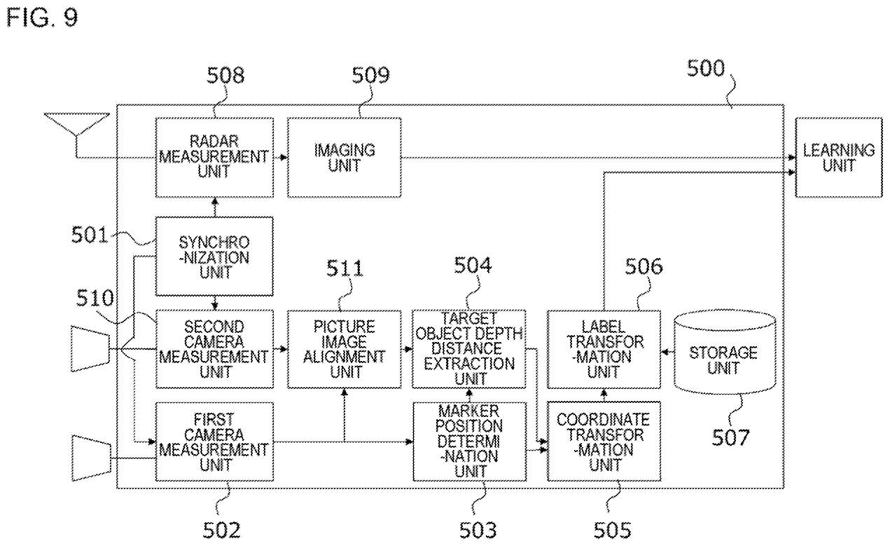

A fifth example embodiment will be described with reference to FIG. 9. A data processing apparatus 500 according to the present example embodiment is different from the second example embodiment only in a marker position determination unit 503 and a target object depth distance extraction unit 504, and therefore description of the other parts is omitted.

The marker position determination unit 503 has the same function as the marker position determination unit 403, and therefore description thereof is omitted.

The target object depth distance extraction unit 504 receives a marker position in a picture image acquired by a first camera from the marker position determination unit 503 and receives a picture image being captured by a second camera and subjected to alignment from a picture image alignment unit 511; and by using the marker position and the picture image, the target object depth distance extraction unit 504 computes the depth distance from the first camera to a target object and outputs the depth distance to a coordinate transformation unit 505. Specifically, the target object depth distance extraction unit 504 extracts the depth at the position of the marker in the first camera picture image by using the aligned second camera picture image and determines the extracted depth to be the depth distance from the first camera to the target object.

### [Description of Operation]

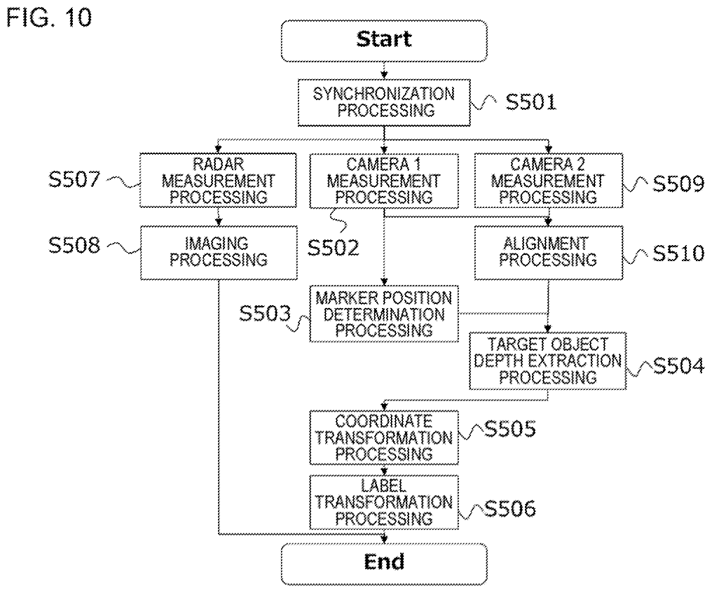

Next, an operation according to the present example embodiment will be described with reference to a flowchart in FIG. 10. The operation other than marker position determination processing (S503) and target object depth extraction processing (S504) is the same as the operation according to the second example embodiment, and therefore description thereof is omitted.

The marker position determination processing (S503) is an operation of the marker position determination unit 503 in FIG. 9; and the processing determines a position of a marker, based on a picture image being acquired by the first camera and being received from a first camera measurement unit 502, outputs the position of the marker to the target object depth distance extraction unit 504, and further outputs the position of the marker to the coordinate transformation unit 505 as a position of a target object.

The target object depth extraction processing (S504) is an operation of the target object depth distance extraction unit 504 in FIG. 9; and the processing computes the depth distance from the first camera to the target object by using the position of the marker in the first camera picture image, the position being received from the marker position determination unit 503, and the aligned second camera picture image received from the picture image alignment unit 511 and outputs the depth distance to the coordinate transformation unit 505.

### [Advantageous Effect]

With respect to a target object the shape of which is unclear in a radar image, the present example embodiment enables more accurate labeling of the target object in the radar image by using a marker.

### Sixth Example Embodiment

### [Configuration]

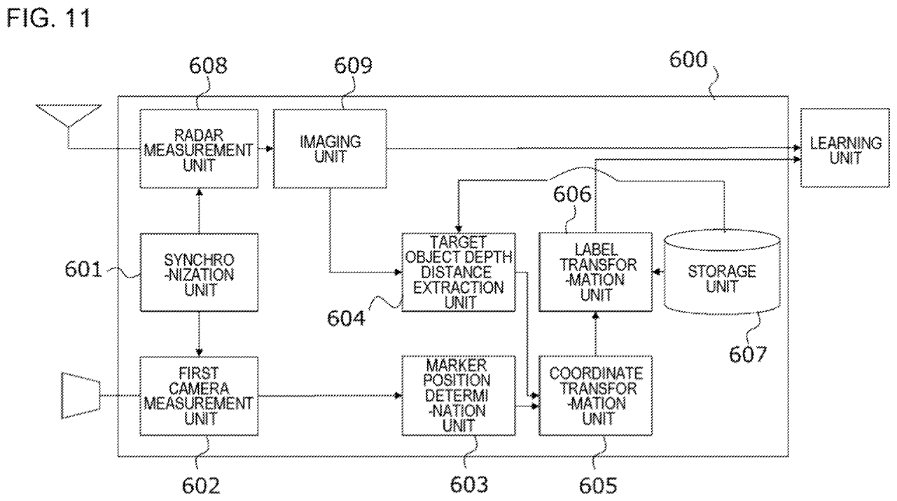

A sixth example embodiment will be described with reference to FIG. 11. The only difference between a data processing apparatus 600 according to the present example embodiment and the third example embodiment is a marker position determination unit 603, and therefore description of the other parts is omitted.

The marker position determination unit 603 receives a picture image acquired by a first camera from a first camera measurement unit 602 as an input, determines a position of a marker in a first camera picture image, and outputs the determined position of the marker to a coordinate transformation unit 605 as a position of a target object. Note that it is assumed that the definition of a marker is the same as that in the description of the marker position determination unit 403.

### [Description of Operation]

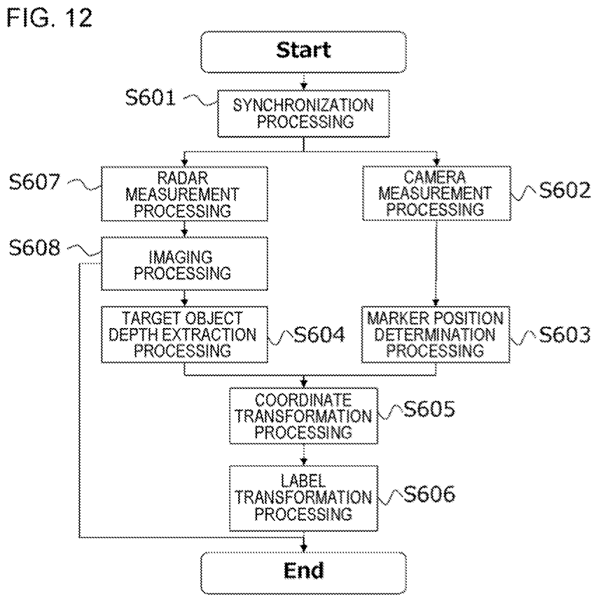

Next, an operation according to the present example embodiment will be described with reference to a flowchart in FIG. 12. The operation other than marker position determination processing (S603) is the same as the operation according to the third example embodiment, and therefore description thereof is omitted.

The marker position determination processing (603) is an operation of the marker position determination unit 603 in FIG. 11; and the processing determines a position of a marker, based on a picture image being captured by the first camera and being received from the first camera measurement unit 602 and outputs the position of the marker to the coordinate transformation unit 605 as a position of a target object.

### [Advantageous Effect]

With respect to a target object the shape of which is unclear in a radar image, the present example embodiment enables more accurate labeling of the target object in the radar image by using a marker.

### Seventh Example Embodiment

### [Configuration]

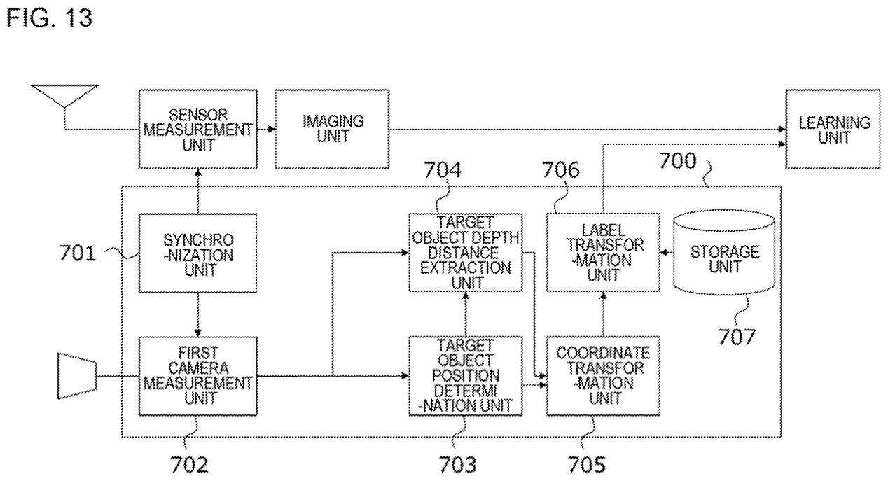

A seventh example embodiment will be described with reference to FIG. 13. A data processing apparatus 700 according to the present example embodiment is acquired by excluding the radar measurement unit 108 and the imaging unit 109 from the configuration according to the first example embodiment. Each processing unit is the same as that according to the first example embodiment, and therefore description thereof is omitted.

Note that a storage unit 707 holds imaging information of a sensor in place of radar imaging information.

### [Description of Operation]

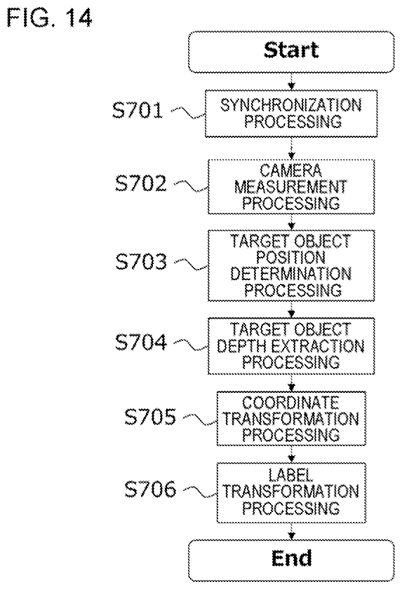

Next, an operation according to the present example embodiment will be described with reference to a flowchart in FIG. 14. The operation is acquired by excluding the radar measurement processing (S107) and the imaging processing (S108) from the operation according to the first example embodiment. Each processing operation is the same as that according to the first example embodiment, and therefore description thereof is omitted.

### [Advantageous Effect]

The present example embodiment also enables labeling of a target object the shape of which is unclear in an image acquired by an external sensor.

### Eighth Example Embodiment

### [Configuration]

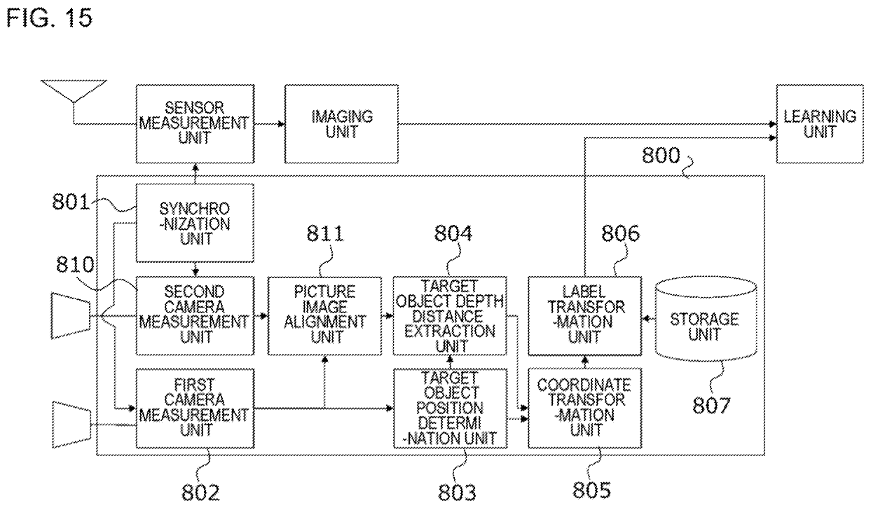

An eighth example embodiment will be described with reference to FIG. 15. A data processing apparatus 800 according to the present example embodiment is acquired by excluding the radar measurement unit 208 and the imaging unit 209 from the configuration according to the second example embodiment. Each processing unit is the same as that according to the second example embodiment, and therefore description thereof is omitted.

### [Description of Operation]

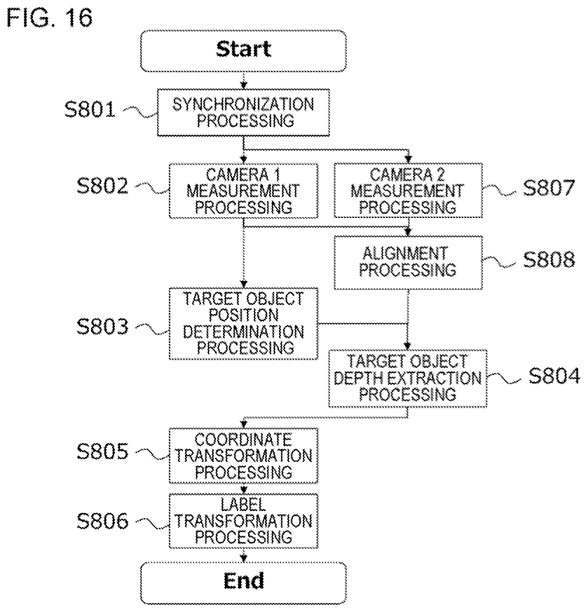

Next, an operation according to the present example embodiment will be described with reference to a flowchart in FIG. 16. The operation is acquired by excluding the radar measurement processing (S207) and the imaging processing (S208) from the operation according to the second example embodiment. Each processing operation is the same as that according to the second example embodiment, and therefore description thereof is omitted.

### [Advantageous Effect]

The present example embodiment also enables labeling of a target object the shape of which is unclear in an image acquired by an external sensor.

### Ninth Example Embodiment

### [Configuration]

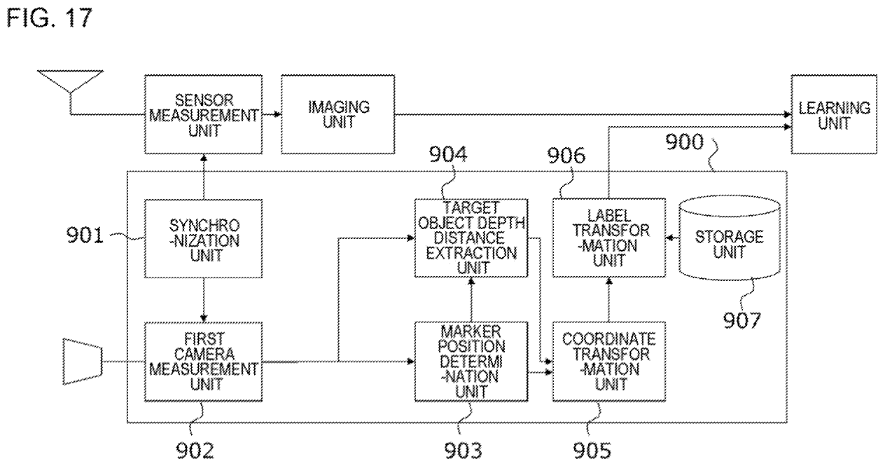

A ninth example embodiment will be described with reference to FIG. 17. A data processing apparatus 900 according to the present example embodiment is acquired by excluding the radar measurement unit 408 and the imaging unit 409 from the configuration according to the fourth example embodiment. Each processing unit is the same as that according to the fourth example embodiment, and therefore description thereof is omitted.

### [Description of Operation]

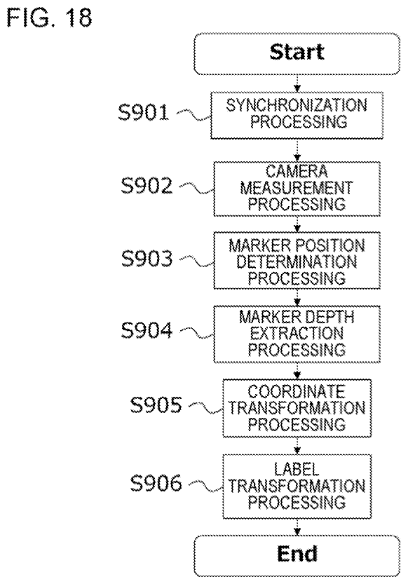

Next, an operation according to the present example embodiment will be described with reference to a flowchart in FIG. 18. The operation is acquired by excluding the radar measurement processing (S407) and the imaging processing (S408) from the operation according to the fourth example embodiment. Each processing operation is the same as that according to the fourth example embodiment, and therefore description thereof is omitted.

### [Advantageous Effect]

With respect to a target object the shape of which is unclear in an image acquired by an external sensor, the present example embodiment also enables more accurate labeling of the target object by using a marker.

### Tenth Example Embodiment

### [Configuration]

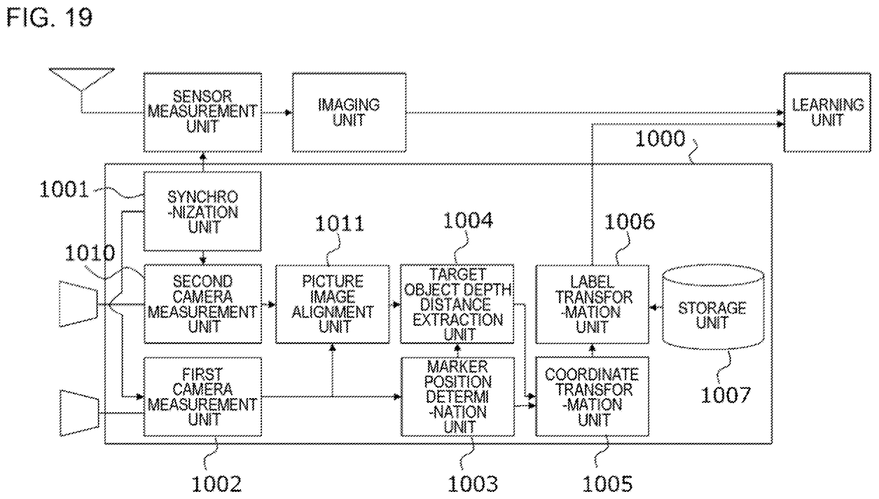

A tenth example embodiment will be described with reference to FIG. 19. A data processing apparatus 1000 according to the present example embodiment is acquired by excluding the radar measurement unit 508 and the imaging unit 509 from the configuration according to the fourth example embodiment. Each processing unit is the same as that according to the fourth example embodiment, and therefore description thereof is omitted.

### [Description of Operation]

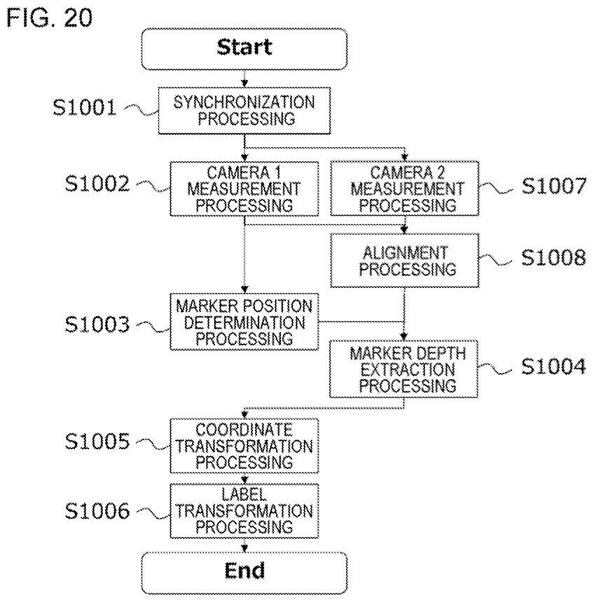

Next, an operation according to the present example embodiment will be described with reference to a flowchart in FIG. 20. The operation is acquired by excluding radar measurement processing (S507) and the imaging processing (S508) from the operation according to the fifth example embodiment. Each processing operation is the same as that according to the fourth example embodiment, and therefore description thereof is omitted.

### [Advantageous Effect]

With respect to a target object the shape of which is unclear in an image acquired by an external sensor, the present example embodiment also enables more accurate labeling of the target object by using a marker.

While the example embodiments of the present invention have been described above with reference to the drawings, the drawings are exemplifications of the present invention, and various configurations other than those described above may be employed.

Further, while each of a plurality of flowcharts used in the description above describes a plurality of processes (processing) in a sequential order, an execution order of processes executed in each example embodiment is not limited to the described order. An order of the illustrated processes may be changed without affecting the contents in each example embodiment. Further, the aforementioned example embodiments may be combined without contradicting one another.

The aforementioned example embodiments may also be described in part or in whole as the following supplementary notes but are not limited thereto.
1. A data processing apparatus including:
   a target object position determination unit determining, based on a picture image acquired by a first camera, a position of a target object in the picture image;
   a target object depth distance extraction unit extracting a depth distance from the first camera to the target object;
   a coordinate transformation unit transforming the position of the target object in the picture image into a position of the target object in a world coordinate system by using the depth distance; and
   a label transformation unit transforming, by using the position of the first camera in the world coordinate system and imaging information used when an image is generated from a measurement result of a sensor, the position of the target object in the world coordinate system into a label of the target object in the image.
2. The data processing apparatus according to 1 described above, wherein
   the imaging information includes a starting point of an area being a target of the image in the world coordinate system and a length per voxel in the world coordinate system in the image.
3. The data processing apparatus according to 1 or 2 described above, wherein
   the target object depth distance extraction unit extracts the depth distance by further using a picture image being generated by a second camera and including the target object.
4. The data processing apparatus according to any one of 1 to 3 described above, wherein
   the target object position determination unit determines the position of the target object by determining a position of a marker mounted on the target object.
5. The data processing apparatus according to 4 described above, wherein
   the target object depth distance extraction unit computes the position of the marker in the picture image acquired by the first camera by using a size of the marker and extracts the depth distance from the first camera to the target object, based on the position of the marker.
6. The data processing apparatus according to any one of 1 to 5 described above, wherein
   the sensor performs measurement using a radar, and
   the data processing apparatus further includes an imaging unit generating a radar image, based on a radar signal generated by the radar.
7. A data processing apparatus including:
   a target object position determination unit determining, based on a picture image acquired by a first camera, a position of a target object in the picture image;
   a target object depth distance extraction unit extracting a depth distance from the first camera to the target object by using a radar image generated based on a radar signal;
   a coordinate transformation unit transforming the position of the target object in the picture image into a position of the target object in a world coordinate system, based on the depth distance; and
   a label transformation unit transforming the target object position in the world coordinate system into a label of the target object in the radar image by using a position of the first camera in the world coordinate system and imaging information of a sensor.
8. A data processing apparatus including:
   a marker position determination unit determining, based on a picture image acquired by a first camera, a position of a marker mounted on a target object in the picture image as a position of the target object in the picture image;
   a target object depth distance extraction unit extracting a depth distance from the first camera to the target object by using a radar image generated based on a radar signal generated by a sensor;
   a coordinate transformation unit transforming the position of the target object in the picture image into a position of the target object in a world coordinate system by using the depth distance from the first camera to the target object; and
   a label transformation unit transforming the position of the target object in the world coordinate system into a label of the target object in the radar image by using a camera position in the world coordinate system and imaging information of the sensor.
9. The data processing apparatus according to 8 described above, wherein
   the marker can be visually recognized by the first camera and cannot be visually recognized by the radar image.
10. The data processing apparatus according to 9 described above, wherein
   the marker is formed by using at least one item out of paper, wood, cloth, and plastic.
11. A data processing method executed by a computer, the method including:
   target object position determination processing of determining, based on a picture image acquired by a first camera, a position of a target object in the picture image;
   target object depth distance extraction processing of extracting a depth distance from the first camera to the target object;
   coordinate transformation processing of transforming the position of the target object in the picture image into a position of the target object in a world coordinate system by using the depth distance; and
   label transformation processing of transforming, by using the position of the first camera in the world coordinate system and imaging information used when an image is generated from a measurement result of a sensor, the position of the target object in the world coordinate system into a label of the target object in the image.
12. The data processing method according to 11 described above, wherein
   the imaging information includes a starting point of an area being a target of the image in the world coordinate system and a length per voxel in the world coordinate system in the image.
13. The data processing method according to 11 or 12 described above, wherein,
   in the target object depth distance extraction processing, the computer extracts the depth distance by further using a picture image being generated by a second camera and including the target object.
14. The data processing method according to any one of 11 to 13 described above, wherein,
   in the target object position determination processing, the computer determines the position of the target object by determining a position of a marker mounted on the target object.
15. The data processing method according to 14 described above, wherein,
   in the target object depth distance extraction processing, the computer computes the position of the marker in the picture image acquired by the first camera by using a size of the marker and extracts the depth distance from the first camera to the target object, based on the position of the marker.
16. The data processing method according to any one of 11 to 15 described above, wherein
   the sensor performs measurement using a radar, and
   the computer further performs imaging processing of generating a radar image, based on a radar signal generated by the radar.
17. A data processing method executed by a computer, the method including:
   target object position determination processing of determining, based on a picture image acquired by a first camera, a position of a target object in the picture image;
   target object depth distance extraction processing of extracting a depth distance from the first camera to the target object by using a radar image generated based on a radar signal;
   coordinate transformation processing of transforming the position of the target object in the picture image into a position of the target object in a world coordinate system, based on the depth distance; and
   label transformation processing of transforming the target object position in the world coordinate system into a label of the target object in the radar image by using a position of the first camera in the world coordinate system and imaging information of a sensor.
18. A data processing method executed by a computer, the method including:
   marker position determination processing of, based on a picture image acquired by a first camera, determining a position of a marker mounted on a target object in the picture image as a position of the target object in the picture image;
   target object depth distance extraction processing of extracting a depth distance from the first camera to the target object by using a radar image generated based on a radar signal generated by a sensor;
   coordinate transformation processing of transforming the position of the target object in the picture image into a position of the target object in a world coordinate system by using the depth distance from the first camera to the target object; and
   label transformation processing of transforming the position of the target object in the world coordinate system into a label of the target object in the radar image by using a camera position in the world coordinate system and imaging information of the sensor.
19. The data processing method according to 18 described above, wherein
   the marker can be visually recognized by the first camera and cannot be visually recognized by the radar image.
20. The data processing method according to 19 described above, wherein
   the marker is formed by using at least one item out of paper, wood, cloth, and plastic.
21. A program causing a computer to include:
   a target object position determination function of determining, based on a picture image acquired by a first camera, a position of a target object in the picture image;
   a target object depth distance extraction function of extracting a depth distance from the first camera to the target object;
   a coordinate transformation function of transforming the position of the target object in the picture image into a position of the target object in a world coordinate system by using the depth distance; and
   a label transformation function of transforming, by using the position of the first camera in the world coordinate system and imaging information used when an image is generated from a measurement result of a sensor, the position of the target object in the world coordinate system into a label of the target object in the image.
22. The program according to 21 described above, wherein
   the imaging information includes a starting point of an area being a target of the image in the world coordinate system and a length per voxel in the world coordinate system in the image.
23. The program according to 21 or 22 described above, wherein
   the target object depth distance extraction function extracts the depth distance by further using a picture image being generated by a second camera and including the target object.
24. The program according to any one of 21 to 23 described above, wherein
   the target object position determination function determines the position of the target object by determining a position of a marker mounted on the target object.
25. The program according to 24 described above, wherein
   the target object depth distance extraction function computes the position of the marker in the picture image acquired by the first camera by using a size of the marker and extracts the depth distance from the first camera to the target object, based on the position of the marker.
26. The program according to any one of 21 to 25 described above, wherein
   the sensor performs measurement using a radar, and the program further causes the computer to include an imaging processing function of generating a radar image, based on a radar signal generated by the radar.
27. A program causing a computer to include:
   a target object position determination function of determining, based on a picture image acquired by a first camera, a position of a target object in the picture image;
   a target object depth distance extraction function of extracting a depth distance from the first camera to the target object by using a radar image generated based on a radar signal;
   a coordinate transformation function of transforming the position of the target object in the picture image into a position of the target object in a world coordinate system, based on the depth distance; and
   a label transformation function of transforming the target object position in the world coordinate system into a label of the target object in the radar image by using a position of the first camera in the world coordinate system and imaging information of a sensor.
28. A program causing a computer to include:
   a marker position determination function of, based on a picture image acquired by a first camera, determining a position of a marker mounted on a target object in the picture image as a position of the target object in the picture image;
   a target object depth distance extraction function of extracting a depth distance from the first camera to the target object by using a radar image generated based on a radar signal generated by a sensor;
   a coordinate transformation function of transforming the position of the target object in the picture image into a position of the target object in a world coordinate system by using the depth distance from the first camera to the target object; and
   a label transformation function of transforming the position of the target object in the world coordinate system into a label of the target object in the radar image by using a camera position in the world coordinate system and imaging information of the sensor.

What is claimed is:

1. A data processing apparatus comprising:
at least one memory configured to store instructions; and
at least one processor configured to execute the instructions to perform operations, the operations comprising:
determining, based on a picture image acquired by a first camera, a position of a target object in the picture image;
extracting a depth distance from the first camera to the target object;
transforming the position of the target object in the picture image into a position of the target object in a world coordinate system by using the depth distance; and
transforming, by using the position of the first camera in the world coordinate system and imaging information used when an image is generated from a measurement result of a sensor, the position of the target object in the world coordinate system into a label of the target object in the image.

2. The data processing apparatus according to claim 1, wherein
the imaging information includes a starting point of an area being a target of the image in the world coordinate system and a length per voxel in the world coordinate system in the image.

3. The data processing apparatus according to claim 1, wherein
the operations comprise extracting the depth distance by further using a picture image being generated by a second camera and including the target object.

4. The data processing apparatus according to claim 1, wherein
the operations comprise determining the position of the target object by determining a position of a marker mounted on the target object.

5. The data processing apparatus according to claim 4, wherein
the operations comprise computing the position of the marker in the picture image acquired by the first camera by using a size of the marker and extracts the depth distance from the first camera to the target object, based on the position of the marker.

6. The data processing apparatus according to claim 1, wherein
the sensor performs measurement using a radar, and
the operations further comprise generating a radar image, based on a radar signal generated by the radar.

7. (canceled)

8. A data processing apparatus comprising:
at least one memory configured to store instructions; and
at least one processor configured to execute the instructions to perform operations, the operations comprising:
determining, based on a picture image acquired by a first camera, a position of a marker mounted on a target object in the picture image as a position of the target object in the picture image;
extracting a depth distance from the first camera to the target object by using a radar image generated based on a radar signal generated by a sensor;
transforming the position of the target object in the picture image into a position of the target object in a world coordinate system by using the depth distance from the first camera to the target object; and
transforming the position of the target object in the world coordinate system into a label of the target object in the radar image by using a camera position in the world coordinate system and imaging information of the sensor.

9. The data processing apparatus according to claim 8, wherein
the marker can be visually recognized by the first camera and cannot be visually recognized by the radar image.

10. The data processing apparatus according to claim 9, wherein
the marker is formed by using at least one item out of paper, wood, cloth, and plastic.

11. A data processing method executed by a computer, the method comprising:
target object position determination processing of determining, based on a picture image acquired by a first camera, a position of a target object in the picture image;
target object depth distance extraction processing of extracting a depth distance from the first camera to the target object;
coordinate transformation processing of transforming the position of the target object in the picture image into a position of the target object in a world coordinate system by using the depth distance; and
label transformation processing of transforming, by using the position of the first camera in the world coordinate system and imaging information used when an image is generated from a measurement result of a sensor, the position of the target object in the world coordinate system into a label of the target object in the image.

12. The data processing method according to claim 11, wherein
the imaging information includes a starting point of an area being a target of the image in the world coordinate system and a length per voxel in the world coordinate system in the image.

13. The data processing method according to claim 11, wherein,
in the target object depth distance extraction processing, the computer extracts the depth distance by further using a picture image being generated by a second camera and including the target object.

14. The data processing method according to claim 11, wherein,
in the target object position determination processing, the computer determines the position of the target object by determining a position of a marker mounted on the target object.

15. The data processing method according to claim 14, wherein,
in the target object depth distance extraction processing, the computer computes the position of the marker in the picture image acquired by the first camera by using a size of the marker and extracts the depth distance from the first camera to the target object, based on the position of the marker.

16. The data processing method according to claim 11, wherein
the sensor performs measurement using a radar, and
the computer further performs imaging processing of generating a radar image, based on a radar signal generated by the radar.

17-20. (canceled)

21. A non-transitory computer-readable medium storing a program for causing a computer to perform operations, the operations comprising:
determining, based on a picture image acquired by a first camera, a position of a target object in the picture image;
extracting a depth distance from the first camera to the target object;
transforming the position of the target object in the picture image into a position of the target object in a world coordinate system by using the depth distance; and
transforming, by using the position of the first camera in the world coordinate system and imaging information used when an image is generated from a measurement result of a sensor, the position of the target object in the world coordinate system into a label of the target object in the image.

22-28. (canceled)
